(19) United States
(12) Patent Application Publication
(10) Pub. No.: US 2018/0330864 A1
(43) Pub. Date: Nov. 15, 2018

(54) COIL COMPONENT

(71) Applicant: SUMIDA CORPORATION, Tokyo (JP)

(72) Inventor: Tomohiro KAJIYAMA, Natori City Miyagi (JP)

(21) Appl. No.: 15/974,098

(22) Filed: May 8, 2018

(30) Foreign Application Priority Data
May 11, 2017 (JP) 2017-094546

(51) Int. Cl. H01F 27/24; H01F 27/28

(52) U.S. Cl. CPC H01F 27/24; H01F 27/2823

(57) ABSTRACT

A coil component including: a first magnetic core including a columnar portion; a second magnetic core having a facing surface which faces one end surface of the columnar portion; a magnetic-gap layer which is constituted by a non-magnetic material, which is arranged between the facing surface and the one end surface, and which forms a magnetic gap between the facing surface and the one end surface; a coil through which the columnar portion is inserted; and a magnetic molded-body which is constituted by a magnetic material and which covers the first magnetic core and the coil, wherein when watching along the axial center direction of the columnar portion, the magnetic-gap layer protrudes to the periphery of the columnar portion.

### CROSS REFERENCES TO RELATED APPLICATIONS

The present application claims priority under 35 U.S.C. § 119 to Japanese Patent Application JP2017-094546 filed on May 11, 2017, the entire contents of which being incorporated herein by reference.

### BACKGROUND OF THE INVENTION

### Field of the Invention

The present invention relates to a coil component.

### Description of the Related Art

As shown in a Patent Document 1 (US unexamined patent publication No. 2011/005064), there exists a coil component which includes a T-shaped magnetic core, a coil through which that magnetic core is inserted, and a magnetic molded-body constituted by a magnetic material and covering the magnetic core and the coil.

### Description of the Related Art

### SUMMARY OF THE INVENTION

For the request with respect to the performance of such a coil component mentioned above, there can be listed such a matter which can have correspondence with a large current, or the like. However, when applying a large current through such a coil component as mentioned above, due to the fact that the magnetic core is easily saturated, it is not always easy to realize the request for the large current. In addition, with respect to such a request, it is a common approach to provide a magnetic gap in the magnetic core which forms a magnetic-path. But when the coil component includes a molded-cover, a lot of man-hours will be required for separately forming the magnetic gap.

The present invention was made in view of the abovementioned problem and is to provide a coil component which can apply a large current with a simple structure.

According to the present invention, there can be provided a coil component including:

a first magnetic core including a columnar portion;

a second magnetic core having a facing surface which faces one end surface of the columnar portion;

a magnetic-gap layer which is constituted by a non-magnetic material, which is arranged between the facing surface and the one end surface, and which forms a magnetic gap between the facing surface and the one end surface;

a coil through which the columnar portion is inserted; and

a magnetic molded-body which is constituted by a magnetic material and which covers the first magnetic core and the coil, wherein
when watching along the axial center direction of the columnar portion, the magnetic-gap layer protrudes to the periphery of the columnar portion.

According to the present invention, it is possible to provide a coil component which can apply a large with a simple structure.

### BRIEF DESCRIPTION OF THE DRAWINGS

FIG. 1 is a front cross-sectional view of a coil component relating to a first exemplified embodiment;

FIG. 2 is a plan view of the coil component relating to the first exemplified embodiment;

FIG. 3A, FIG. 3B and FIG. 3C are cross-sectional views showing a series of processes for manufacturing the coil component relating to the first exemplified embodiment;

FIG. 4 is a perspective view corresponding to the state of FIG. 3C;

FIG. 5 is a front cross-sectional view showing one example of a more detailed structure of a magnetic-gap layer;

FIG. 6 is a front cross-sectional view of a coil component relating to a second exemplified embodiment;

FIG. 7 is a front cross-sectional view of a coil component relating to a third exemplified embodiment;

FIG. 8 is a front cross-sectional view of a coil component relating to a fourth exemplified embodiment; and

FIG. 9 is a front cross-sectional view of a coil component relating to a fifth exemplified embodiment.

### DESCRIPTION OF THE PREFERRED EMBODIMENTS

Hereinafter, there will be explained exemplified embodiments of the present invention by using the drawings. It should be noted in the all drawings that the same reference numerals are applied for the similar constituents and the explanations thereof will be appropriately omitted.

### First Exemplified Embodiment

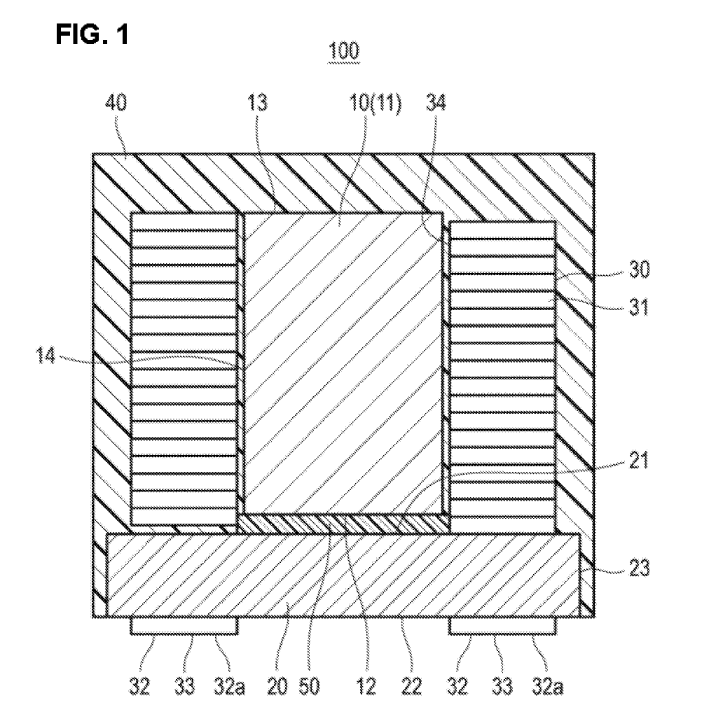

First, there will be explained a coil component 100 relating to a first exemplified embodiment by using FIG. 1 to FIG. 5.

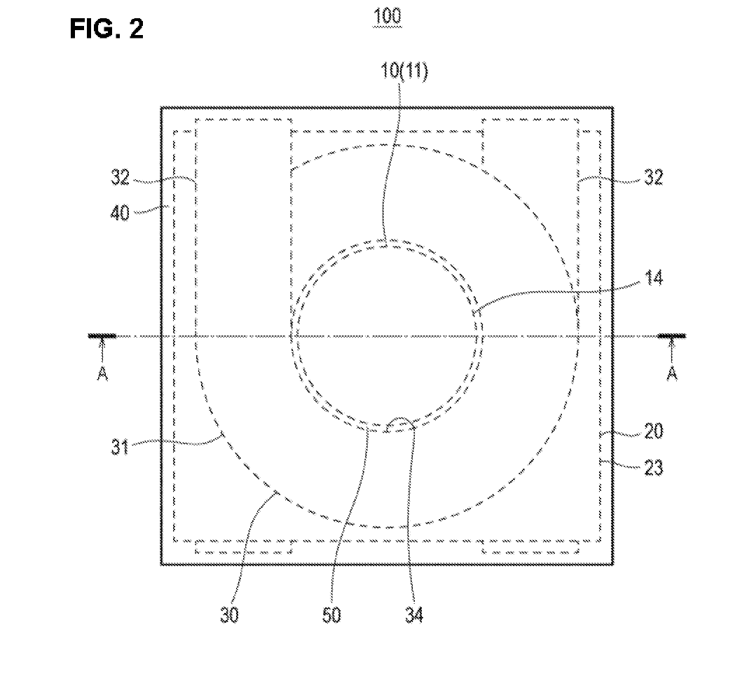

As shown in either one of FIG. 1 and FIG. 2, the coil component 100 relating to the present exemplified embodiment includes: a first magnetic core 10 including a columnar portion 11; a second magnetic core 20 having a facing surface (a first main surface 21 in a case of the present exemplified embodiment) which faces one end surface 12 of the columnar portion 11; a magnetic-gap layer 50 which is constituted by a non-magnetic material, which is arranged between the facing surface and the one end surface 12, and which forms a magnetic gap between the facing surface and the one end surface 12; a coil 30 through which the columnar portion 11 is inserted; and a magnetic molded-body 40 which is constituted by a magnetic material and which covers the first magnetic core 10 and the coil 30. Then, as shown in FIG. 2, when watching the coil component 100 in the axial center direction of the columnar portion 11, the magnetic-gap layer 50 protrudes to the periphery of the columnar portion 11.

When watching the coil component 100 in the axial center direction of the columnar portion 11, the magnetic-gap layer 50 protrudes to the periphery of the columnar portion 11, there exists a clearance between the inner circumferential surface 34 of the coil 30 and the side circumferential surface 14 of the columnar portion 11, in which even if a portion of the magnetic molded-body 40 intrudes into this clearance, it is possible to prevent the magnetic-flux flow through the first magnetic core 10 and the second magnetic core 20 and therefore, the magnetic-gap layer 50 can work as a magnetic gap well. As the result thereof, it is possible to obtain a better DC superimposition characteristic comparing with that of the old coil component. More specifically, it is possible to improve the DC superimposition characteristic. In this manner, according to the present exemplified embodiment, it is possible to provide a coil component 100 which can apply a large current with a simple structure. In addition, when watching the coil component 100 in the axial center direction of the columnar portion 11, by adjusting the protrusion size of the magnetic-gap layer 50 from the columnar portion 11, it is possible to adjust the L-value.

In a case of the present exemplified embodiment, the first magnetic core 10 is formed in a columnar shape (for example, in a cylindrical shape). In other words, the whole of the first magnetic core 10 is formed as the columnar portion 11. The first magnetic core 10 includes one end surface 12 and the other end surface 13 which are arranged, for example, in parallel to each other.

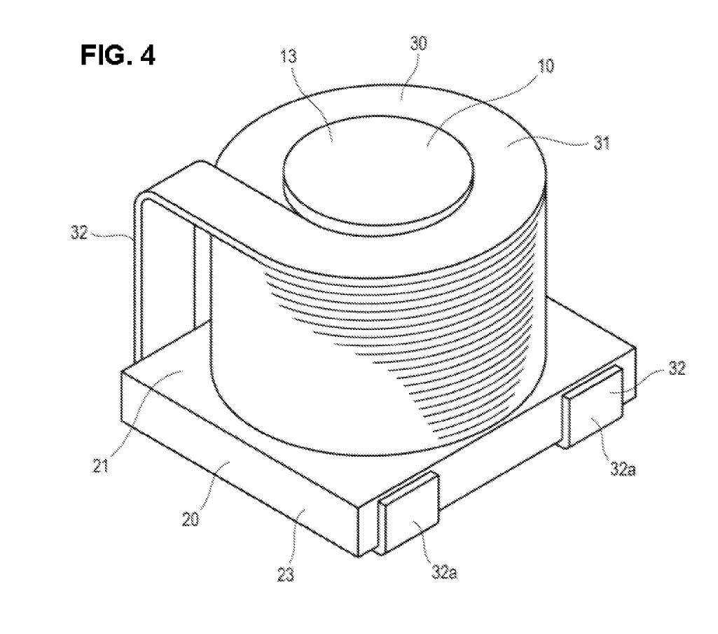

In addition, in a case of the present exemplified embodiment, the second magnetic core 20 is a plate-shaped core which is formed in a plate-shape. There is no limitation in particular for the planar shape of the second magnetic core 20. And it is shown, for example, from FIG. 2 and FIG. 4, the planar shape of the second magnetic core 20 is formed in a rectangular shape and the second magnetic core 20 is formed in a rectangular-parallelepiped shape. The second magnetic core 20 includes a first main surface 21 and a second main surface 22 which are arranged in parallel to each other.

Within the first main surface 21 and the second main surface 22 of the second magnetic core 20, the first main surface 21 faces the one end surface 12 of the first magnetic core 10. In more detail, the first main surface 21 and the one end surface 12 are facing in parallel with each other.

In this manner, in a case of the present exemplified embodiment, the coil component 100 includes a T-shaped core which is constituted by combining the columnar (stick-shaped) first magnetic core 10 and the plate-shaped second magnetic core 20.

It should be noted that it is preferable for the one end surface 12 to be faced with respect to the center portion of the first main surface 21.

In this manner, in a case of the present exemplified embodiment, the second magnetic core 20 is a plate-shaped core and the abovementioned facing surface is formed as the first main surface 21 which is one main surface of the plate-shaped core.

It is preferable for the magnetic-gap layer 50 to be arranged along a portion of the outer surface of the second magnetic core 20. In more detail, in a case of the present exemplified embodiment, the magnetic-gap layer 50 is arranged along a portion of the first main surface 21.

In a case of the present exemplified embodiment, as shown in FIG. 2, when watching the coil component 100 in the axial center direction of the columnar portion 11, the magnetic-gap layer 50 protrudes outwardly from the entire peripheral circumference of the columnar portion 11. More specifically, when watching the coil component 100 in the axial center direction of the columnar portion 11, the columnar portion 11 is accommodated within the inside of the outline of the magnetic-gap layer 50.

In a case of the present exemplified embodiment, when watching the coil component 100 in the axial center direction of the columnar portion 11, the outline of the magnetic-gap layer 50 is accommodated within the inside of the outline of the second magnetic core 20. In more detail, for example, the magnetic-gap layer 50 is formed such that the outline of the magnetic-gap layer 50 takes an equivalent position as the inner circumferential surface 34 of the coil 30. It is allowed for the outline of the magnetic-gap layer 50 to be in contact with the inner circumferential surface 34 of the coil 30.

The magnetic-gap layer 50 is constituted by a material which has an insulation property and also which is formed by a nonmagnetic body.

There is no limitation for the thickness of the magnetic-gap layer 50. In this example, it can be, for example, 0.01 mm or more and 1.0 mm or less, and it also can be 0.1 mm or less.

It should be noted that it is preferable to form the magnetic-gap layer 50 in the facing space between the one end surface 12 and the first main surface 21 so as to prevent the magnetic molded-body 40 from intruding thereinto. The magnetic molded-body 40 is constituted by containing a magnetic material and has permeability higher than that of air. By preventing such a magnetic molded-body 40 from intruding into the facing space between the one end surface 12 and the first main surface 21 by using the magnetic-gap layer 50, it is possible to improve the DC superimposition characteristic of the coil component 100.

For such kind of the magnetic-gap layer 50, there can be cited various kinds of examples which will be explained hereinafter.

For example, it is possible to constitute the magnetic-gap layer 50 by a resin material containing granular fillers. In this case, for example, it is possible to set the facing distance (size) between the one end surface 12 of the columnar portion 11 and the first main surface 21 of the second magnetic core 20. That is, the thickness size of the magnetic-gap layer 50 is nearly equal to the maximum particle size of the filler.

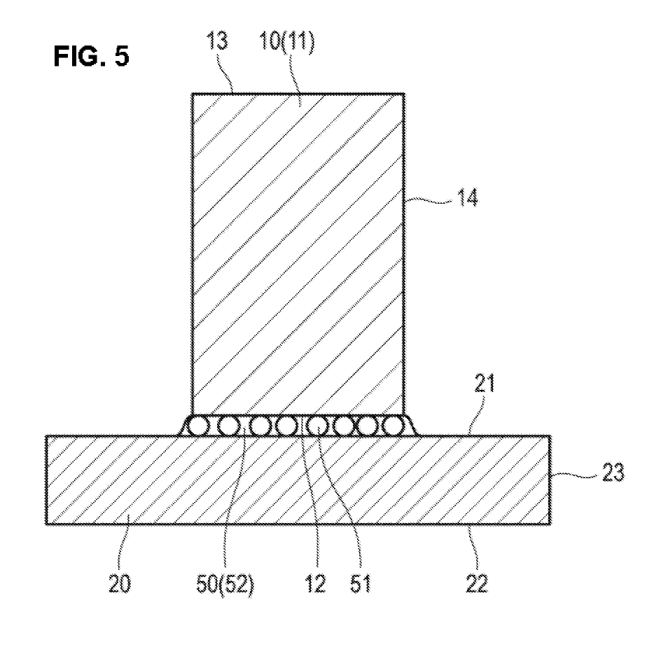

In this manner, as shown in FIG. 5 for one example, the magnetic-gap layer 50 is constituted by a resin material containing granular fillers 51 which define the facing distance between the one end surface 12 of the columnar portion 11 and the first main surface 21 of the second magnetic core 20.

In this case, it is easily possible to set the thickness size of the magnetic-gap layer 50, that is, the thickness size of the magnetic gap to be a desired thickness by adjusting the particle size of the filler 51 and therefore, it becomes easily possible to set the DC superimposition characteristic and the L-value of the coil component 100 to be desired characteristics.

There is no limitation for the particle size of the filler 51, but it is possible, for example, to select 0.03 mm or more and 0.075 mm or less. The particle size of the filler 51 means the diameter thereof in a case in which the filler 51 has a spherical shape and means the cross-section diameter thereof in a case in which the filler 51 has a columnar shape.

The abovementioned filler 51 can be formed, for example, as an inorganic particle. When molding the magnetic molded-body 40 by being compressed by a mold, it is preferable to select the filler 51 having sufficiently structural strength so as not to be deformed (not to be diameter-reduced) when the filler 51 is sandwiched between the first magnetic core 10 and the second magnetic core 20.

It is possible for such a filler 51 to use, for example, one kind, two kinds or more kinds of materials selected from: a carbon material such as graphite, carbon black, diamond or the like; a silicate such as mica or glass; an oxide such as titanium oxide or alumina; and a silicon compound such as magnesium silicate, fused silica or crystalline silica.

In a case of constituting the magnetic-gap layer 50 by a resin material containing the granular filler 51, it is preferable for the resin material containing the granular filler 51 to be an adhesive agent. For example, by coating this adhesive agent on the first main surface 21, bonding the first main surface 21 and the one end surface 12 through the adhesive agent, and curing the aforesaid adhesive agent, it is possible to bonding the first magnetic core 10 and the second magnetic core 20. And at the same time, it is possible to provide the magnetic-gap layer 50.

For example, it is possible for the coating area of the adhesive agent with respect to the first main surface 21 to be equal to the formation area of the magnetic-gap layer 50. More specifically, the adhesive agent can be coated with respect to the first main surface 21 in an area wider than that of the one end surface 12 (in an area including the one end surface 12) and thereafter, the one end surface 12 is adhesively-fixed on the first main surface 21 through the adhesive agent. However, the coating area of the adhesive agent with respect to the first main surface 21 is not limited by this example.

For the base-material resin of the resin material included in the magnetic-gap layer 50, which contains the granular filler 51, there can be cited such as an acrylic resin, a vinyl chloride resin, an epoxy resin, a vinyl acetate resin, an urethane resin, an alkyd resin, a melamine resin, a silicon resin and the like. For the base-material resin, there can be cited a resin of a water dispersion type, of a water-soluble type, of a solvent type, of a solvent free type and the like.

It should be noted that the process of coating the adhesive agent constituting the magnetic-gap layer 50 is not limited by a single process and it is allowed to form the magnetic-gap layer 50 by coating the adhesive agent on the second magnetic core 20 by using a plurality of divided processes.

In addition, it is also allowed for the magnetic-gap layer 50 to be a coating layer which is formed partially with respect to the first main surface 21 of the second magnetic core 20.

In this case, it is possible to provide the magnetic-gap layer 50 by applying the coating partially on the first main surface 21 of the second magnetic core 20.

It is possible for the coating layer to be constituted by a hard resin material such as an epoxy-based resin, an acrylic resin, a silicon resin and the like.

In the process of coating this resin material, a resin material is coated by a coating width such that the thickness of the magnetic-gap layer 50 after cured becomes a desired thickness.

Also in this case, the process of coating the resin material constituting the magnetic-gap layer 50 is not limited by a single process and it is allowed to form the magnetic-gap layer 50 by coating the resin material on the second magnetic core 20 by using a plurality of divided processes.

In addition, it is also allowed for the magnetic-gap layer 50 to be a plate-shaped spacer or a sheet-shaped film which is bonded with respect to the first main surface 21 and the one end surface 12.

In this case, by bonding a spacer or a film prepared in advance between the first main surface 21 and the one end surface 12, it is possible to provide the magnetic-gap layer 50.

In this case, the thickness size of the magnetic-gap layer 50 can be adjusted by setting the thickness size of the spacer or the film to be a predetermined thickness size in advance.

It should be noted that there is no limitation for the material of the spacer or the film, but it is possible, for example, to employ a resin material.

In addition, it is also allowed for the magnetic-gap layer 50 to be a sheet-shaped adhesive tape which is stuck with respect to at least one of the first main surface 21 and the one end surface 12.

It should be noted that it is allowed for the adhesive tape to be a double-sided tape which is adhesive for the both sides thereof. And it is also allowed to be a single-sided tape which is adhesive for the single side thereof. In a case in which the adhesive tape is a double-sided adhesive tape, it is possible to apply the adhesive tape to both of the first main surface 21 and the one end surface 12. In a case in which the adhesive tape is a single-sided adhesive tape, it is possible to apply the adhesive tape to one of the first main surface 21 and the one end surface 12, and to employ an adhesive agent with the other thereof for the bonding thereof.

In this case, it is possible for the thickness size of the magnetic-gap layer 50 to be adjusted by selecting the thickness of the adhesive tape to be used.

In addition, it is allowed for the magnetic-gap layer 50 to be constituted by including a plurality of resin wires arranged in parallel with one another. Alternatively, it is also allowed for the magnetic-gap layer 50 to be constituted by including a plurality of resin wires arranged in a lattice shape.

For example, caused by the fact that the one end surface 12 and the first main surface 21 are bonded through an adhesive agent by sandwiching these plurality of wires therebetween, the magnetic-gap layer 50 is constituted by the plurality of wires and the adhesive agent.

In a case in which the plurality of wires are arranged in parallel with one another, the facing distance between the one end surface 12 and the first main surface 21 becomes approximately equal to the outer diameter of the wire (the maximum outer diameter of the wire).

On the other hand, in a case in which the plurality of wires are arranged in a lattice shape, the facing distance between the one end surface 12 and the first main surface 21 becomes approximately equal to the sum of the outer diameters of the vertically extended wire and the laterally extended wire at the intersecting portion of these wires.

In addition, it is also allowed for the magnetic-gap layer 50 to be formed by a combination of the various kinds of constitutions mentioned above. More specifically, it is allowed for the magnetic-gap layer 50 to be constituted by including two kinds or more of the following portions, that is, a portion constituted by a resin material containing granular fillers, a portion constituted by a coating layer formed partially on the first main surface 21 of the second magnetic core 20, a portion constituted by a plate-shaped spacer bonded on the first main surface 21 and one end surface 12, a portion constituted by a sheet-shaped adhesive tape which is stuck to at least one of the first main surface 21 and the one end surface 12, and a portion constituted by including a plurality of wires arranged in parallel with one another or in a lattice shape.

In this case, it is allowed for the two kinds or more of portions to be mutually stacked with respect to one another or it is also allowed to be arranged at different positions on the surface of the second magnetic core 20.

As shown in FIG. 1, FIG. 2 and FIG. 4, the coil 30 is constituted by winding-around a metal-made wire 31 in a spiral shape. The coil 30 is arranged on the first main surface 21 of the second magnetic core 20 by taking a configuration in which the axis of the aforesaid coil 30 is arranged orthogonally with respect to the first main surface 21 of the second magnetic core 20. Through the inside of the inner circumferential surface 34 of the coil 30, there is inserted the columnar portion 11 of the first magnetic core 10.

Both of the end portions of the coil 30 are formed as extended portions 32 respectively. The extended portion 32 is a portion which is extended from a spiral-shaped portion of the coil 30 (hereinafter, this portion is also referred to merely as a spiral portion). A portion of the extended portion 32 engages with respect to the side circumferential surface 23 and the second main surface 22 of the second magnetic core 20, wherein there is constituted a second core holding portion 32a which holds the second magnetic core 20. Further, a portion of the second core holding portion 32a, that is, for example, the portion extending along the second main surface 22 constitutes a terminal portion 33.

The spiral portion of the coil 30 is an assembly of a plurality of winding portions which are arranged spirally in a single connection. Each winding portion is a portion which circles around the periphery of the columnar portion 11 by one turn at the spiral portion of the coil 30.

It is preferable for the coil 30 to be formed as a tightly-wound coil in which the mutually neighboring winding portions within the respective winding portions of the aforesaid coil 30 are in close contact with each other in the axial center direction of the spiral portion.

The present exemplified embodiment presents an example in which the wire 31 is a rectangular wire and the coil 30 is an edgewise coil. More specifically, the coil 30 is an edgewise coil constituted by a rectangular wire and there exists a clearance between the inner circumferential surface 34 of the coil 30 and the side circumferential surface 14 of the columnar portion 11. For example, this clearance is wider than the space (winding pitch) between the mutual winding portions which mutually neighbors in the axial direction of the spiral portion within the plurality of winding portions constituting the spiral portion of the coil 30.

In a case in which the coil 30 is an edgewise coil, it is difficult to form the coil 30 by winding the wire 31 around the periphery of the columnar portion 11 and therefore, normally, an air-core coil 30 is formed beforehand by winding-around the wire 31 and thereafter, the columnar portion 11 is inserted through the coil 30. In this case, a clearance easily occurs between the inner circumferential surface 34 of the coil 30 and the side circumferential surface 14 of the columnar portion 11 and therefore, the intrusion of the magnetic molded-body 40 into this clearance will easily occur.

On the other hand, in the present exemplified embodiment, when watching the coil component 100 in the axial center direction of the columnar portion 11, the magnetic-gap layer 50 protrudes to the periphery of the columnar portion 11. And there exists a clearance between the inner circumferential surface 34 of the coil 30 and the side circumferential surface 14 of the columnar portion 11, in which even if a portion of the magnetic molded-body 40 intrudes into this clearance, it is possible to prevent the magnetic-flux flow through the first magnetic core 10 and the second magnetic core 20 and therefore, the function of the magnetic gap constituted by the magnetic-gap layer 50 can be made more sufficient.

It should be noted in the present invention that it is allowed for the coil 30 to have a structure other than an edgewise coil, and in which it is allowed for the wire 31 to be a wire such as a round wire other than a rectangular wire.

The columnar portion 11 is inserted through the coil 30. In a case of the present exemplified embodiment, the first magnetic core 10 is inserted through the coil 30. It should be noted that the coil 30 and the first magnetic core 10 are arranged such that the axis of the spiral portion coil 30 and the axis of the columnar portion 11 coincide with each other. There exists a clearance between the inner circumferential surface 34 of the spiral portion of the coil 30 and the side circumferential surface 14 of the columnar portion 11.

The magnetic molded-body 40 covers the peripheries of the first magnetic core 10 and the coil 30 and at the same time, covers the side circumferential surface 23 of the second magnetic core 20 which is a plate-shaped core.

In more detail, in a case of the present exemplified embodiment, the whole of the first magnetic core 10 and the coil 30, and the whole surface of the first main surface 21 of the second magnetic core 20 and the whole surface of the side circumferential surface 23 thereof are embedded in the magnetic molded-body 40.

A portion of the magnetic molded-body 40 intrudes also into the clearance between the inner circumferential surface 34 of the coil 30 and the side circumferential surface 14 of the columnar portion 11 and intrudes also into the clearance between the spiral portion of the coil 30 and the second magnetic core 20.

In a case of the present exemplified embodiment, the second main surface 22 of the second magnetic core 20 is exposed from the magnetic molded-body 40. In more detail, for example, the whole surface of the second main surface 22 is exposed from the magnetic molded-body 40.

Therefore, the terminal portion 33 (the portion extending along the second main surface 22) of the coil 30 is exposed from the magnetic molded-body 40.

The coil component 100 is constituted as mentioned above.

It should be noted that the coil component 100 is, for example, an inductor, a choke coil or the like.

Next, there will be explained one example of a method of manufacturing the coil component 100. Here, there will be explained a case in which the magnetic-gap layer 50 is constituted by a resin material containing the granular fillers 51.

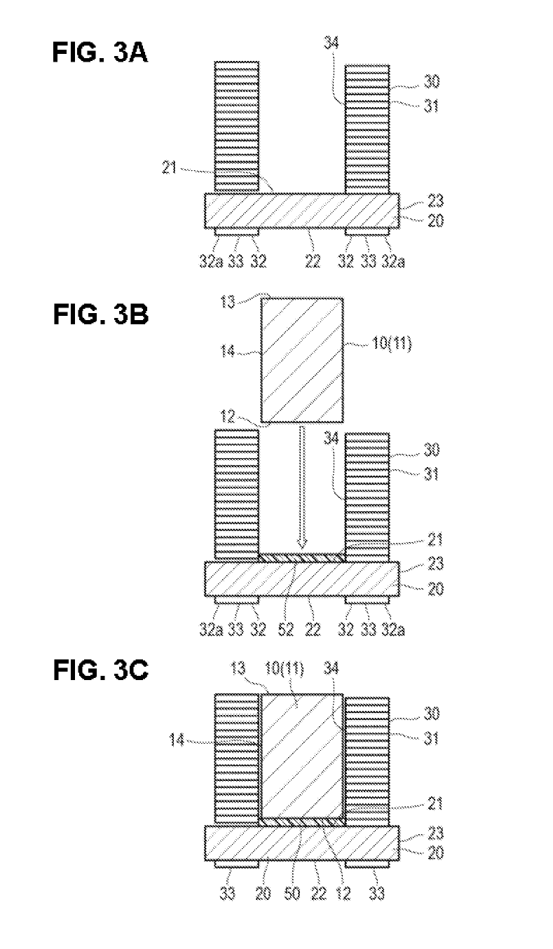

First, the second magnetic core 20 and the coil 30 are prepared, and the coil 30 is assembled with respect to the second magnetic core 20. More specifically, as shown in FIG. 3A, the second core holding portions 32a of the pair of the extended portions 32 of the coil 30 are made to engage respectively with respect to the side circumferential surface 23 and the second main surface 22 of the second magnetic core 20. FIG. 4 is a perspective view corresponding to the state of this drawing FIG. 3C.

Next, as shown in FIG. 3B, a resin material (adhesive agent 52) which becomes the magnetic-gap layer 50 is coated on the first main surface 21 of the second magnetic core 20. Then the first magnetic core 10 is inserted into the coil 30, and the one end surface 12 of the first magnetic core 10 is pressed with respect to the first main surface 21 of the second magnetic core 20 through the magnetic-gap layer 50.

Thus, the adhesive agent 52 is crushed and the filler 51 contained in the aforesaid adhesive agent 52 is arranged in a single layer (see FIG. 5).

Thereafter, caused by the fact that the adhesive agent 52 is cured, the magnetic-gap layer 50 is formed as shown in FIG. 5 and at the same time, the one end surface 12 of the first magnetic core 10 and the first main surface 21 of the second magnetic core 20 are bonded together (see FIG. 3C, FIG. 5). It should be noted that the illustration of the coil 30 is omitted in FIG. 5.

Thereafter, the semifinished-product shown in FIG. 3C is set in a mold and magnetic powders which become the magnetic molded-body 40 are filled in the mold. Thus, the first magnetic core 10, the coil 30, the magnetic-gap layer 50 and the side circumferential surface 23 of the second magnetic core 20, which constitute the coil component 100, are embedded in the magnetic powders.

Next, by pressurizing the magnetic powders in the mold, the magnetic molded-body 40 is formed.

Here, a putty-like (clay-like) admixture of the magnetic powders is put into the mold by a dispenser, a press machine, a dedicated tool or the like.

The putty-like (clay-like) admixture is manufactured by mixing metal magnetic powders, whose main component is iron by adding chromium, silicon, manganese or the like, and a resin such as an epoxy resin, a silicon resin or the like. A solvent (terpineol or the like) is added if necessary.

For example, it is preferable to contain the solvent as less than 2% wt (or not by containing the solvent) in the putty-like admixture. And the constituent ratio of the metal magnetic powders (mixed powders obtained by a combination of amorphous metal magnetic powders which contains at least iron, silicon and chromium and iron-silicon-chromium based alloy powders by the constituent weight-ratio 1:1) and the epoxy resin is made to be within the weight-ratios from 91:9 to 96:4. This admixture has a high viscosity and has an enough low liquidity so that different from the liquid, the admixture does not flow or spread even if the lump of the admixture is placed on a plane surface. The putty-like admixture is filled in the mold by applying a pressure.

Next, under predetermined drying conditions (temperature-condition and time-condition in the drying process), the solvent is evaporated from the admixture and the filled admixture is dried. It should be noted that in a case of manufacturing the admixture without containing the solvent, it is possible to omit this drying process.

Next, under predetermined curing conditions (temperature-condition and time-condition in the curing process), there is carried out a thermosetting-process in which the admixture is thermally cured in a heat curing furnace either when the simifinished coil component is placed in the inside of the mold or when it is taken-out from the mold. Thus, the magnetic molded-body 40 is formed. Thereafter, the coil component 100 is taken out from the mold. It should be noted that there is carried out, if necessary, the polishing of the surface of the magnetic molded-body 40.

In addition, it is allowed for the abovementioned drying process and the abovementioned thermosetting-process to be carried out in the same heating apparatus and under the same heating condition.

According to the first exemplified embodiment as described above, the coil component 100 includes: the first magnetic core 10 including the columnar portion 11; the second magnetic core 20 having the first main surface 21 which faces the one end surface 12 of the columnar portion 11; the magnetic-gap layer 50 including a non-magnetic material, which is arranged between the first main surface 21 and the one end surface 12, and which forms a magnetic gap between the first main surface 21 and the one end surface 12; the coil 30 through which the columnar portion 11 is inserted; and the magnetic molded-body 40 which is constituted by a magnetic material and which covers the first magnetic core 10 and the coil 30. Then, when watching the coil component 100 in the axial center direction of the columnar portion 11, the magnetic-gap layer 50 protrudes to the periphery of the columnar portion 11.

In this example, there exists a clearance between the inner circumferential surface 34 of the coil 30 and the side circumferential surface 14 of the columnar portion 11. Even if a portion of the magnetic molded-body 40 intrudes into that clearance, magnetic-gap layer 50 can work as the magnetic gap well, and it is possible to improve the DC superimposition characteristic of the coil component 100. In addition, it is possible to adjust the L-value easily.

### Second Exemplified Embodiment

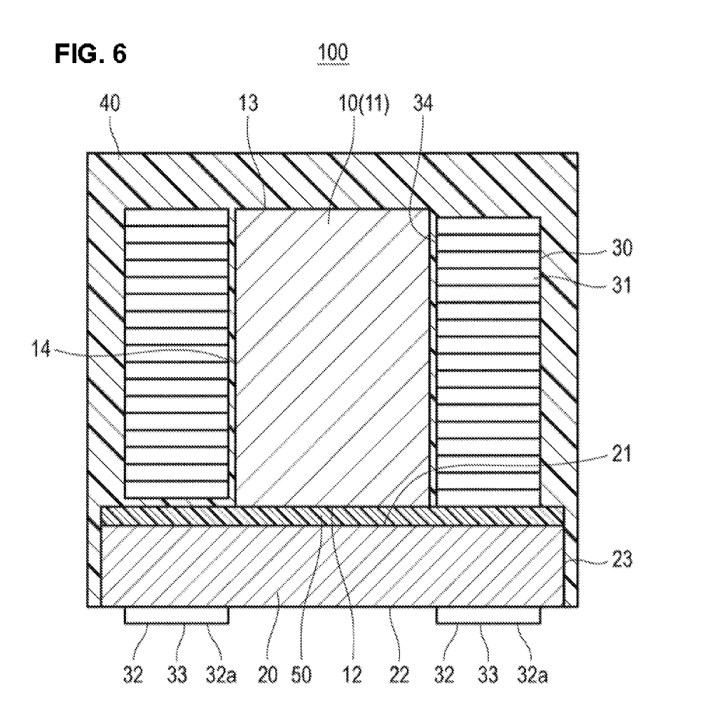

Next, there will be explained a coil component 100 relating to a second exemplified embodiment by using FIG. 6.

The coil component 100 relating to the present exemplified embodiment is different from the coil component 100 relating to the abovementioned first exemplified embodiment in an aspect which will be explained hereinafter, wherein in the other aspects, it is constituted similarly as the coil component 100 relating to the abovementioned first exemplified embodiment.

In a case of the present exemplified embodiment, the magnetic-gap layer 50 intervenes also between the first main surface 21 of the second magnetic core 20 and the coil 30.

More specifically, the magnetic-gap layer 50 is arranged also between the facing surface (first main surface 21) and the coil 30, in which the magnetic gap is constituted also between the facing surface and the coil 30.

Thus, it is possible to realize a constitution in which the coil 30 and the facing surface (first main surface 21) are spaced through the magnetic-gap layer 50 and therefore, the internal pressure resistance of the coil component 100 is improved and at the same time, there can be obtained a more preferable DC superimposition characteristic.

It should be noted in a case of the present exemplified embodiment that the L-value thereof is lowered compared with that of the abovementioned first exemplified embodiment.

In more detail, in a case of the present exemplified embodiment, the magnetic-gap layer 50 is arranged on the whole surface of the facing surface (first main surface 21).

In this example, the internal pressure resistance of the coil component 100 is improved more securely. And at the same time, since the magnetic gap is formed also between the magnetic molded-body 40 and the second magnetic core 20, there can be obtained a furthermore preferable DC superimposition characteristic.

In addition, since magnetic-gap layer 50 is formed on the whole surface of the facing surface (first main surface 21), the formation of the magnetic-gap layer 50 become easier, and at the same time, it is possible to more enlarge the formation area of the magnetic gap.

### Third Exemplified Embodiment

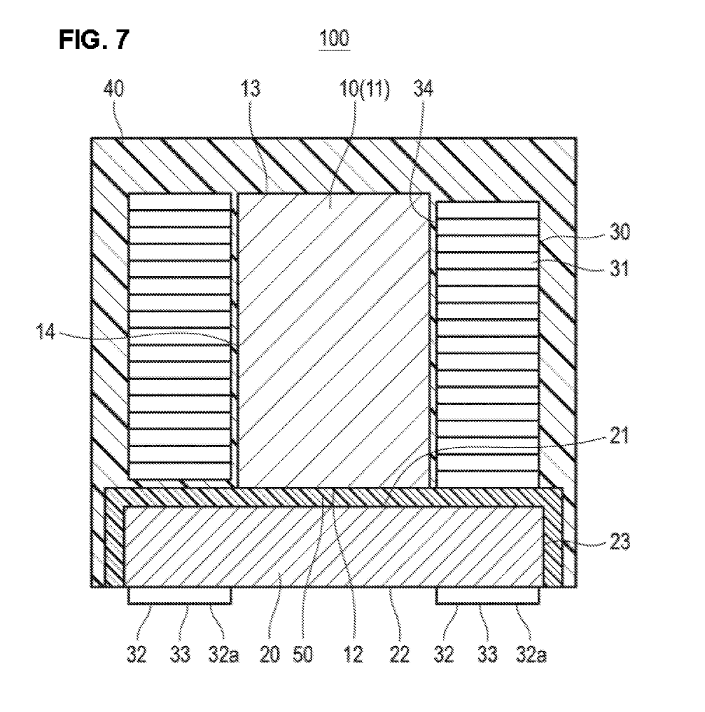

Next, there will be explained a coil component 100 relating to a third exemplified embodiment by using FIG. 7.

The coil component 100 relating to the present exemplified embodiment is different from the coil component 100 relating to the abovementioned second exemplified embodiment in an aspect which will be explained hereinafter, wherein in the other aspects, it is constituted similarly as the coil component 100 relating to the abovementioned second exemplified embodiment.

In a case of the present exemplified embodiment, the magnetic-gap layer 50 intervenes also between the side circumferential surface 23 of the second magnetic core 20 and the part of the magnetic molded-body 40 which covers the circumferential surface 23.

In this manner, in a case of the present exemplified embodiment, the magnetic molded-body 40 covers the side circumferential surface 23 of the plate-shaped core (the second magnetic core 20). And the magnetic-gap layer 50 is arranged also between the side circumferential surface 23 of the plate-shaped core and the magnetic molded-body 40, and there is formed a magnetic gap also between the side circumferential surface 23 of the plate-shaped core and the part of the magnetic molded-body 40 which covers the circumferential surface 23.

By employing such a constitution, it is possible to obtain further excellent DC superimposition characteristic.

### Fourth Exemplified Embodiment

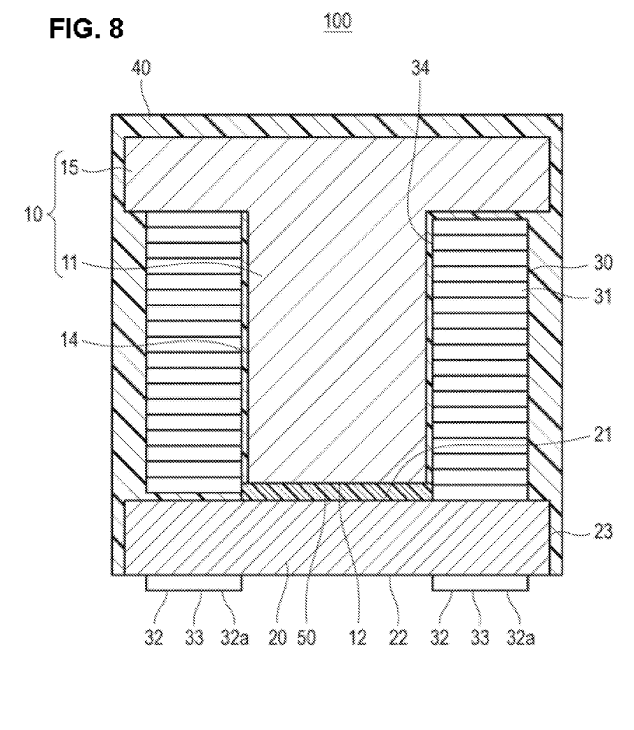

Next, there will be explained a coil component 100 relating to a fourth exemplified embodiment by using FIG. 8.

The coil component 100 relating to the present exemplified embodiment is different from the coil component 100 relating to the abovementioned first exemplified embodiment in an aspect which will be explained hereinafter, wherein in the other aspects, it is constituted similarly as the coil component 100 relating to the abovementioned first exemplified embodiment.

In a case of the present exemplified embodiment, the first magnetic core 10 is a T-shaped core. More specifically, the first magnetic core 10 in the present exemplified embodiment is constituted by including a columnar portion 11 having a similar shape as that of the first magnetic core 10 in the first exemplified embodiment and a plate-shaped portion 15 linked to the end portion which is positioned at the opposite side of the one end surface 12 for the columnar portion 11. The planar shape of the plate-shaped portion 15 is wider than the planar shape of the columnar portion 11.

The coil 30 is arranged between the first main surface 21 of the second magnetic core 20 and the plate-shaped portion 15.

Also by the present exemplified embodiment, it is possible to obtain a similar effect as that of the first exemplified embodiment.

It should be noted in FIG. 8 that there is shown an example in which the formation area of the magnetic-gap layer 50 is similar as that of the first exemplified embodiment (FIG. 1), but also for this exemplified embodiment, it is allowed to employ a configuration in which the formation area of the magnetic-gap layer 50 is made to be similar as that of the second exemplified embodiment (FIG. 6) or the third exemplified embodiment (FIG. 7) and by employing such a configuration, it is possible to obtain similar effects as those of the second exemplified embodiment or the third exemplified embodiment.

In addition, FIG. 8 shows an example in which the magnetic molded-body 40 covers the upper surface and the side circumferential surface of the plate-shaped portion 15, but it is allowed for the upper surface of the plate-shaped portion 15 to be exposed from the magnetic molded-body 40. In addition, it is also allowed for the side circumferential surface of the plate-shaped portion 15 to be exposed from the magnetic molded-body 40.

### Fifth Exemplified Embodiment

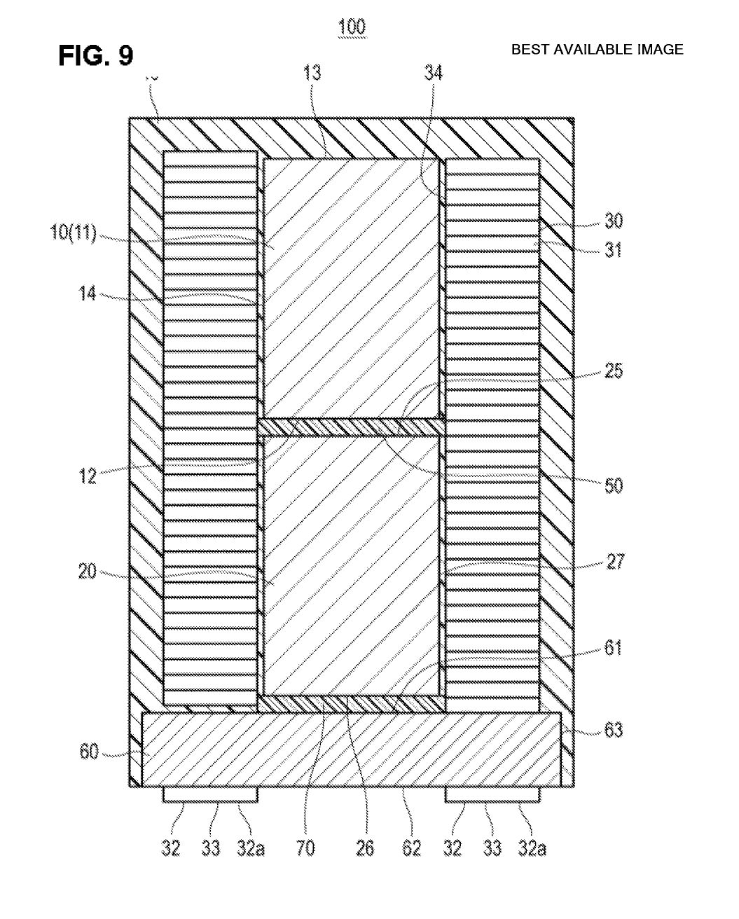

Next, there will be explained a coil component 100 relating to a fifth exemplified embodiment by using FIG. 9.

The coil component 100 relating to the present exemplified embodiment is different from the coil component 100 relating to the abovementioned first exemplified embodiment in an aspect which will be explained hereinafter, wherein in the other aspects, it is constituted similarly as the coil component 100 relating to the abovementioned first exemplified embodiment.

In a case of the present exemplified embodiment, each of the first magnetic core 10 and the second magnetic core 20 is formed in a columnar shape (for example, cylindrical shape). The shape of the first magnetic core 10 is the same as explained in the first exemplified embodiment. The second magnetic core 20 includes one end surface 25 and the other end surface 26 which are arranged in parallel with each other. Both of the first magnetic core 10 and the second magnetic core 20 are formed to have the same diameters. The first magnetic core 10 and the second magnetic core 20 are inserted through the coil 30. The axis of the first magnetic core 10 and the axis of the second magnetic core 20 are arranged coaxially each other.

The one end surface 25 of the second magnetic core 20 faces the one end surface 12 of the first magnetic core 10 (for example, faces in parallel each other).

There is arranged a magnetic-gap layer 50 between the one end surface 12 of the first magnetic core 10 and the one end surface 25 of the second magnetic core 20. In a case of the present exemplified embodiment, when watching the coil component 100 in the axial center direction of the columnar portion 11 (the first magnetic core 10), the magnetic-gap layer 50 protrudes to the periphery of the columnar portion 11 (the first magnetic core 10) and concurrently, protrudes to the periphery of the second magnetic core 20.

The coil component 100 relating to the present exemplified embodiment further includes a third magnetic core 60. The third magnetic core 60 is a core similar with the second magnetic core 20 in the first exemplified embodiment. More specifically, the third magnetic core 60 is a plate-shaped core formed in a plate-shape and includes a first main surface 61 and a second main surface 62 which are arranged in parallel with each other. Then, the first main surface 61 of the third magnetic core 60 and the other end surface 26 of the second magnetic core 20 are facing each other (for example, facing in parallel with each other).

There is arranged a magnetic-gap layer 70 between the other end surface 26 of the second magnetic core 20 and the first main surface 61 of the third magnetic core 60. The magnetic-gap layer 70 is a layer similar with the magnetic-gap layer 50 in the first exemplified embodiment. When watching the coil component 100 in the axial center direction of the columnar portion 11 (the first magnetic core 10), the magnetic-gap layer 70 protrudes to the periphery of the second magnetic core 20.

In a case of the present exemplified embodiment, caused by the fact that when watching the coil component 100 in the axial center direction of the columnar portion 11, the magnetic-gap layer 50 protrudes to the periphery of the columnar portion 11 and concurrently, protrudes to the periphery of the second magnetic core 20, it is possible to prevent the magnetic flux flow through the first magnetic core 10 and the second magnetic core 20 and therefore, the function of the magnetic gap constituted by the magnetic-gap layer 50 can be made sufficient.

Further, caused by the fact that when watching the coil component 100 in the axial center direction of the columnar portion 11, the magnetic-gap layer 70 protrudes to the periphery of the second magnetic core 20, it is possible to prevent the magnetic flux flow through the second magnetic core 20 and the third magnetic core 60 and therefore, the function of the magnetic gap constituted by the magnetic-gap layer 70 can be made sufficient.

As the result thereof, it is possible to obtain a DC superimposition characteristic which exceeds whichever one of the DC superimposition characteristics of the materials of the first magnetic core 10, the second magnetic core 20 and the third magnetic core 60. In addition, when watching the coil component 100 in the axial center direction of the columnar portion 11, by adjusting the protrusion size of the magnetic-gap layer 50 from the columnar portion 11 and by adjusting the protrusion size of the magnetic-gap layer 70 from the second magnetic core 20, it is possible to adjust the L-value.

As described above, each of the exemplified embodiments was explained with reference to the accompanying drawings, but these embodiments are merely exemplifications of the present invention and it is possible to employ various kinds of constitutions other than the abovementioned constitutions. In addition, it is possible to combine the abovementioned each respective exemplified embodiments appropriately within the scope without departing from the gist of the present invention.

For example, the shape of each of the magnetic cores (the first magnetic core 10, the second magnetic core 20 and the third magnetic core 60) is not limited by the above-mentioned examples so long as the first magnetic core 10 includes the columnar portion 11. It is enough if there is employed a configuration in which the magnetic-gap layer is arranged between the magnetic cores within the multiple magnetic cores which are molded by the magnetic molded-body 40 and which are arranged side by side adjacently, and in which when watching the coil component in the aligning direction of these adjacent magnetic cores, the magnetic-gap layer protrudes from the outline of at least one magnetic core thereof.

The present exemplified embodiment includes the following technical ideas.

(1) A coil component including:

a first magnetic core including a columnar portion;

a second magnetic core having a facing surface which faces one end surface of the columnar portion;

a magnetic-gap layer which is constituted by a non-magnetic material, which is arranged between the facing surface and the one end surface, and which forms a magnetic gap between the facing surface and the one end surface;

a coil through which the columnar portion is inserted; and

a magnetic molded-body which is constituted by a magnetic material and which covers the first magnetic core and the coil, wherein

when watching in the axial center direction of the columnar portion, the magnetic-gap layer protrudes to the periphery of the columnar portion.

(2) The coil component according to Idea (1), wherein the magnetic-gap layer is arranged also between the facing surface and the coil, and there is formed a magnetic gap also between the facing surface and the coil.

(3) The coil component according to Idea (2), wherein the magnetic-gap layer is arranged on the whole surface of the facing surface.

(4) The coil component according to any one of Ideas (1) to (3), wherein

the second magnetic core is a plate-shaped core, and

the facing surface is one of the main surfaces of the aforesaid plate-shaped core.

(5) The coil component according to Idea (4), wherein

the magnetic molded-body covers the side circumferential surface of the plate-shaped core, and

the magnetic-gap layer is arranged also between the side circumferential surface of the plate-shaped core and the magnetic molded-body, and there is formed a magnetic gap also between the side circumferential surface of the plate-shaped core and the portion of the magnetic molded-body which corresponds to the side circumferential surface of the plate-shaped core.

(6) The coil component according to any one of Ideas (1) to (5), wherein the magnetic-gap layer is constituted by a resin material containing a granular filler which defines the facing distance between the one end surface and the facing surface.

(7) The coil component according to any one of Ideas (1) to (6), wherein

the coil is an edgewise coil which is constituted by a rectangular wire, and

there exists a clearance between the inner circumferential surface of the coil and the side circumferential surface of the columnar portion.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A coil component comprising:
a first magnetic core including a columnar portion;
a second magnetic core having a facing surface which faces one end surface of the columnar portion;
a magnetic-gap layer which is constituted by a non-magnetic material, which is arranged between the facing surface and the one end surface, and which forms a magnetic gap between the facing surface and the one end surface;
a coil through which the columnar portion is inserted; and
a magnetic molded-body which is constituted by a magnetic material and which covers the first magnetic core and the coil, wherein
when watching along the axial center direction of the columnar portion, the magnetic-gap layer protrudes to the periphery of the columnar portion.

2. The coil component according to claim 1, wherein the magnetic-gap layer is arranged also between the facing surface and the coil, and there is formed a magnetic gap also between the facing surface and the coil.

3. The coil component according to claim 2, wherein the magnetic-gap layer is arranged on the whole surface of the facing surface.

4. The coil component according to claim 1, wherein
the second magnetic core is a plate-shaped core, and
the facing surface is one of the main surfaces of the aforesaid plate-shaped core.

5. The coil component according to claim 4, wherein
the magnetic molded-body covers the side circumferential surface of the plate-shaped core; and
the magnetic-gap layer is arranged also between the side circumferential surface of the plate-shaped core and the magnetic molded-body, and there is formed a magnetic gap also between the side circumferential surface of the plate-shaped core and the portion of the magnetic molded-body which corresponds to the side circumferential surface of the plate-shaped core.

6. The coil component according to claim 1, wherein the magnetic-gap layer is constituted by a resin material containing a granular filler which defines the facing distance between the one end surface and the facing surface.

7. The coil component according to claim 1, wherein
the coil is an edgewise coil which is constituted by a rectangular wire, and
there exists a clearance between the inner circumferential surface of the coil and the side circumferential surface of the columnar portion.
